(19) United States
(12) Patent Application Publication
(10) Pub. No.: US 2026/0089816 A1
(43) Pub. Date: Mar. 26, 2026

(54) MICROWAVE ANTENNA, MICROWAVE GENERATING APPARATUS, AND HEAT TREATMENT APPARATUS

(71) Applicant: SEMES CO., LTD., Cheonan-si (KR)

(72) Inventors: Yoon Seok CHOI, Cheonan-si (KR); In Ho KIM, Cheonan-si (KR); Han Lim KANG, Cheonan-si (KR); Tae Hun KANG, Cheonan-si (KR)

(73) Assignee: SEMES CO., LTD., Cheonan-si (KR)

(21) Appl. No.: 19/223,206

(22) Filed: May 30, 2025

(30) Foreign Application Priority Data
Sep. 23, 2024 (KR) 10-2024-0128442

(51) Int. Cl. H05B 6/72

(52) U.S. Cl. CPC H05B 6/72

(57) ABSTRACT

Proposed are a microwave antenna, and a microwave generating apparatus and a heat treatment apparatus including the microwave antenna. In the heat treatment apparatus using microwaves, the microwave antenna includes a ring frame configured to constitute a waveguide for microwaves, a first slot which is a space formed through an inner wall surface of the ring frame, and a second slot which is a space formed through a lower surface of the ring frame, wherein the second slot is formed at a tilting angle with respect to a direction perpendicular to the inner wall surface.

### CROSS REFERENCE TO RELATED APPLICATION

The present application claims priority to Korean Patent Application No. 10-2024-0128442, filed Sep. 23, 2024, the entire contents of which are incorporated herein for all purposes by this reference.

### BACKGROUND OF THE INVENTION

### Field of the Invention

The present disclosure relates to a microwave antenna, and a microwave generating apparatus and a heat treatment apparatus including the microwave antenna.

### Description of the Related Art

Semiconductor (or display) manufacturing is a process of manufacturing semiconductor devices on a substrate (e.g., wafer), and includes, for example, exposure, deposition, etching, ion implantation, cleaning, etc. In order to perform each manufacturing process, semiconductor manufacturing equipment for performing individual processes is provided in cleanrooms of a semiconductor manufacturing plant so that a process is performed on a substrate put into the semiconductor manufacturing equipment.

During substrate processing, a heat treatment process may be performed to modify the surface state of a substrate after dry etching or atomic layer etching (ALE). Heat treatment using microwaves may be applied for the heat treatment process of a substrate. In a heat treatment device using microwaves, a microwave antenna is positioned at the top of a chamber, several slots are formed in the microwave antenna, and a substrate is heated by microwaves transmitted through the slots.

Meanwhile, in the heat treatment process of a substrate, it is important that the entire area of the substrate is heated uniformly. Typically, a microwave antenna generates a microwave (MW) cavity mode using a single polarization mode. That is, microwaves aligned in a specific direction are transmitted to the substrate to perform heat treatment. However, when a single polarization mode is used, it has been found that the temperature uniformity of the circular wafer-shaped substrate deteriorates.

### SUMMARY

Accordingly, the present disclosure has been made keeping in mind the above problems occurring in the related art, and an objective of the present disclosure is to provide a microwave antenna capable of improving the temperature uniformity of a substrate, and a microwave generating apparatus and a heat treatment apparatus including the microwave antenna.

A microwave antenna according to the present disclosure includes: a ring frame configured to constitute a waveguide for microwaves; a first slot which is a space formed through an inner wall surface of the ring frame; and a second slot which is a space formed through a lower surface of the ring frame, wherein the second slot may be formed at a tilting angle with respect to a direction perpendicular to the inner wall surface.

In an embodiment of the present disclosure, the tilting angle may be less than or equal to 90 degrees.

In an embodiment of the present disclosure, the tilting angle may be 45 degrees.

In an embodiment of the present disclosure, a p-wave component and an s-wave component perpendicular to the p-wave component of a microwave may be emitted through the second slot.

In an embodiment of the present disclosure, by adjusting the tilting angle, a ratio of the p-wave component and the s-wave component of the microwave emitted through the second slot may be adjusted.

In an embodiment of the present disclosure, the p-wave component of the microwave passing through the second slot may overlap with a p-wave component of a microwave passing through the first slot to form a first microwave radiation pattern. The s-wave component passing through the second slot may not interfere with the p-wave and may form a second microwave radiation pattern.

A microwave generating apparatus according to the present disclosure may include: a microwave power source; a waveguide connected to the microwave power source; and a microwave antenna connected to the waveguide.

A heat treatment apparatus using microwaves according to the present disclosure may include: a chamber configured to constitute a processing space for a substrate; a dielectric window configured to cover the top of the chamber; and a microwave antenna located on top of the dielectric window and providing microwaves to the processing space.

According to the present disclosure, by allowing microwaves to propagate through a first slot formed on the inner wall surface of a ring frame and a second slot formed at an angle inclined from the lower surface of the ring frame, a plurality of microwave cavity modes are generated with a plurality of polarizations orthogonal to each other, and various microwave radiation patterns are transmitted to a substrate due to the ring mode mix effect, thereby improving the temperature uniformity of the substrate.

### BRIEF DESCRIPTION OF THE DRAWINGS

FIG. 1 shows a heat treatment apparatus according to the present disclosure.

FIG. 2 shows the structure of upper part in FIG. 1.

FIG. 3 shows a microwave antenna viewed from above.

FIGS. 4 and 5 show the pattern of microwaves propagated through a microwave antenna.

FIGS. 6A and 6B show the analysis results for the temperature distribution on a substrate according to the configuration of a slot in a microwave antenna.

FIG. 7 shows a plasma processing apparatus according to the present disclosure.

### DETAILED DESCRIPTION

Hereinafter, with reference to the accompanying drawings, embodiments of the present disclosure will be described in detail so that those skilled in the art may easily carry out the present disclosure. The present disclosure may be embodied in many different forms and is not limited to the embodiments set forth herein.

In order to clearly describe the present disclosure, parts irrelevant to the description are omitted, and the same reference numerals are assigned to the same or similar components throughout the specification.

In addition, in various embodiments, components having the same configuration will be described only in representative embodiments by using the same reference numerals, and in other embodiments, only configurations different from the representative embodiments will be described.

Throughout the specification, when a part is said to be “connected (or coupled)” to another part, this includes not only the case of being “directly connected (or coupled)” but also “indirectly connected (or coupled)” with another member in between. In addition, when a part “includes”, “has”, or “comprises” a certain part, this means that other components may be further included without excluding other components unless otherwise stated.

Unless otherwise defined, all terms used herein, including technical or scientific terms, have the same meaning as commonly understood by a person skilled in the art. Terms such as those defined in the commonly used dictionaries should be construed as having meanings consistent with the meanings in the context of the related art and shall not be construed as ideal or excessively formal meanings unless expressly defined in this application.

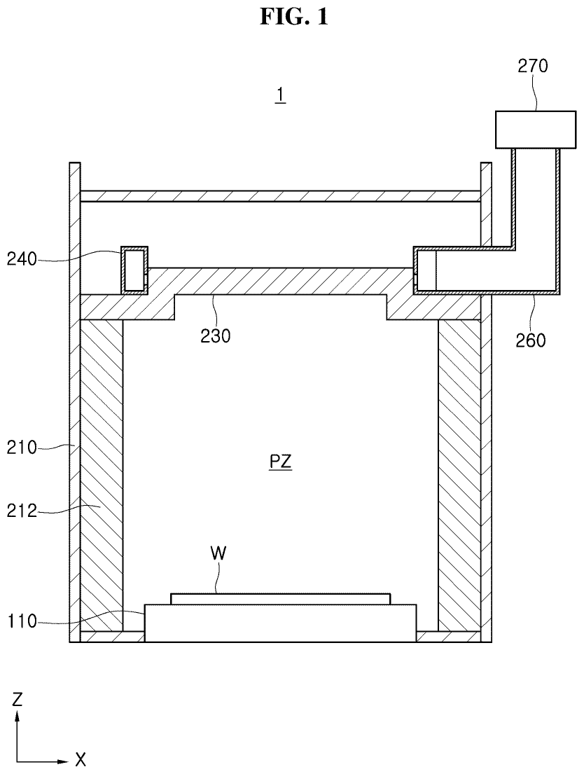

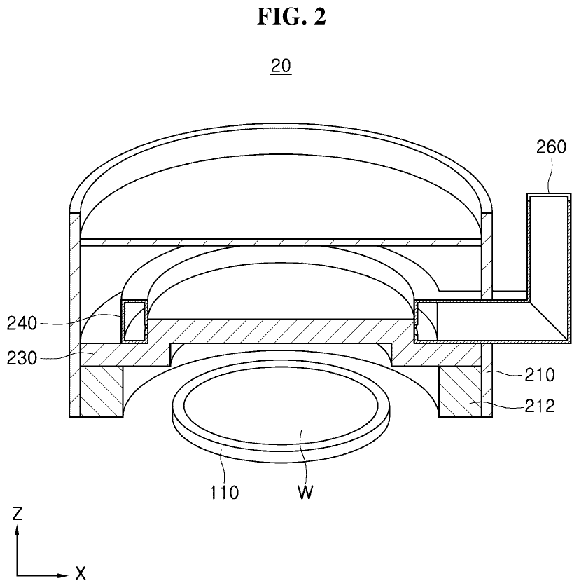

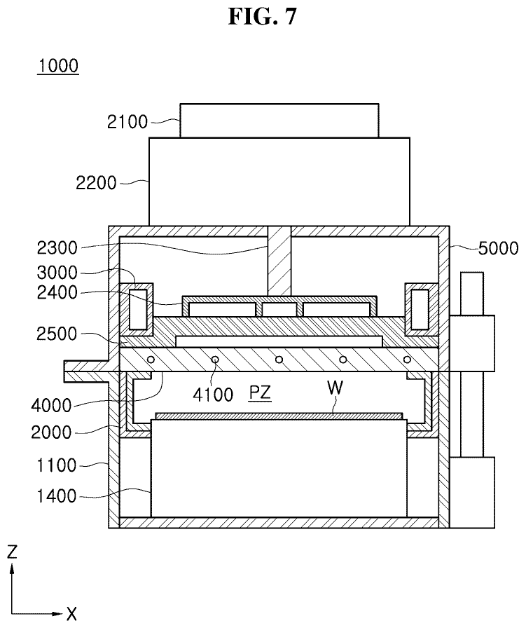

FIGS. 1 and 2 show a heat treatment apparatus 1 according to the present disclosure. The heat treatment apparatus 1 according to the present disclosure is a device that performs heat treatment on a substrate W such as a wafer. The heat treatment apparatus 1 heats the substrate W by applying microwaves to the substrate W. The heat treatment apparatus 1 may perform annealing that alters the surface state of the substrate W. The heat treatment apparatus 1 may be integrated into a plasma processing apparatus 1000 of FIG. 7.

The heat treatment apparatus 1 according to the present disclosure includes: a chamber 212 forming a processing space PZ for a substrate W; a dielectric window 230 covering the top of the chamber 212; and a microwave antenna 240 located on top of the dielectric window 230 and providing microwaves to the processing space PZ. In the heat treatment apparatus 1, the chamber 212 is located at the inner lower part of a housing 210, and the substrate W is positioned inside the chamber 212. A support member 110 is disposed at the lower part of the processing space PZ, and the substrate W is supported by the support member 110. Although not shown, a door through which the substrate W enters and exits may be provided in the chamber 212.

The dielectric window 230 covering the processing space PZ is placed at the top of the chamber 212. The dielectric window 230 seals the processing space PZ formed by the chamber 212 while transmitting microwaves. The edge of the dielectric window 230 is supported by the chamber 212. The center of the dielectric window 230 may protrude upward from the edge. The microwave antenna 240 may be located on top of the dielectric window 230.

The microwave antenna 240 provides microwaves provided from a microwave power source 270 to the processing space PZ of the chamber 212 through the dielectric window 230. The microwave antenna 240 and the microwave power source 270 are connected through a waveguide 260. A stub tuner for impedance matching may be coupled to the output terminal of the microwave power source 270. The microwave antenna 240 is provided in a ring shape.

The microwave power source 270, the waveguide 260, and the microwave antenna 240 constitute a microwave generating apparatus. The microwave generating apparatus includes the microwave power source 270, the waveguide 260 connected to the microwave power source 270, and the microwave antenna 240 connected to the waveguide 260.

The microwave antenna 240 may emit microwaves in an inward and downward directions. The microwave antenna 240 radiates microwaves toward the dielectric window 230, and the microwaves pass through the dielectric window 230 and propagate to the processing space PZ. A reflector for reflecting the microwaves may be provided at the upper center of the dielectric window 230.

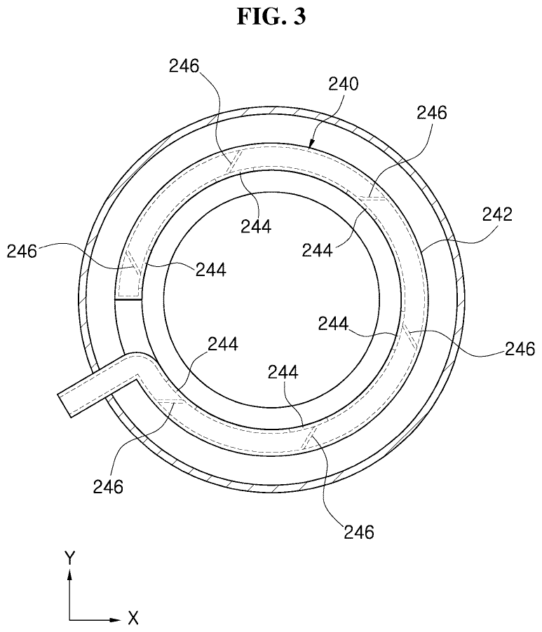

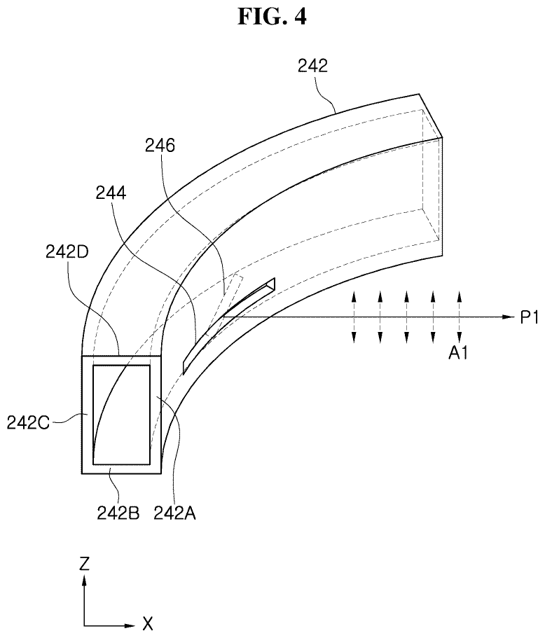

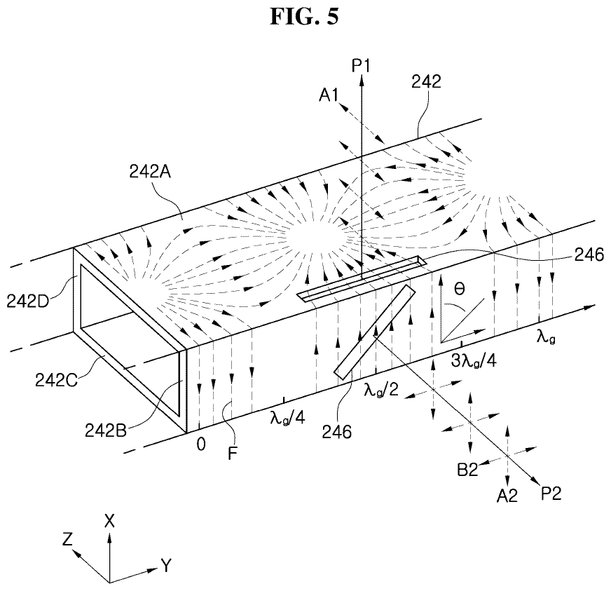

FIG. 3 shows the microwave antenna 240 viewed from above. The microwave antenna 240 includes: a ring frame 242 constituting a waveguide for microwaves; a first slot 244 which is a space formed through an inner wall surface 242A (see FIG. 4) of the ring frame 242; and a second slot 246 which is a space formed through a lower surface 242B (see FIG. 4) of the ring frame 242. The second slot 246 is formed at a tilting angle with respect to the direction perpendicular to the inner surface 242A (X direction in FIG. 5).

Referring to FIG. 3, the ring frame 242 of the microwave antenna 240 is provided in a ring shape. A part of the ring frame 242 is connected to the waveguide 260. When viewed from above, the ring frame 242 has a ring shape in which a part thereof is closed. An empty space is formed inside the ring frame 242. The cross section of the ring frame 242 is provided in a square shape. The ring frame 242 has the inner surface 242A, the lower surface 242B, an outer wall surface 242C, and an upper surface 242D.

The first slot 244 is formed on the inner surface 242A of the ring frame 242, and the second slot 246 is formed on the lower surface 242B of the ring frame 242. The first slot 244 is formed on the inner surface 242A of the ring frame 242. A plurality of first slots 244 is formed on the inner surface 242A of the ring frame 242. The first slots 244 may be formed at regular intervals along the circumference of the ring frame 242. The first slot 244 and the second slot 246 may be located together at adjacent positions.

A plurality of second slots 246 is formed on the lower surface 242B of the ring frame 242. The second slots 246 may be formed at regular intervals along the circumference of the ring frame 242. The second slot 246 is formed by tilting at a certain tilting angle θ with respect to the direction perpendicular to the inner surface 242A of the ring frame 242. The reason why the second slot 246 is formed at the tilting angle θ with respect to the direction perpendicular to the inner wall surface 242A is to generate multiple microwave radiation patterns, and the details thereof will be explained later.

The first slot 244 and the second slot 246 may form a set and be arranged at regular intervals along the circumference of the ring frame 242. The first slot 244 and the second slot 246 each have a long axis and a short axis. The first slot 244 and the second slot 246 each have the long axis in the circumferential direction of the ring frame 242 and the short axis in the direction perpendicular to the long axis.

FIGS. 4 and 5 show the pattern of microwaves propagated through the microwave antenna. FIG. 4 shows a part of the ring frame 242 where the first slot 244 and the second slot 246 are located in FIG. 3, and FIG. 5 shows a part of the ring frame 242 modeled in a square shape as viewed from below. In FIG. 5, microwaves propagate along the ring frame 242 and current is generated on the surface, and a p-polarized wave component of the microwaves propagating through the first slot 244 and the second slot 246 has a polarization direction parallel to a current direction F. The current direction F is formed in a certain pattern according to a wavelength λ_{g} of the microwave. A p-wave, also known as a transverse magnetic TM wave, is a wave whose vibration direction is parallel to the plane of incidence. An s-polarized wave, also known as a transverse electric (TE) wave, is a wave whose vibration direction is perpendicular to the plane of incidence.

Referring to FIGS. 4 and 5, the second slot 246 provided on the lower surface 242B of the ring frame 242 is formed in a direction inclined by the tilting angle θ with respect to a direction perpendicular to the inner surface 242A. The second slot 246 is not formed in a direction perpendicular or parallel to the first slot 244, but has the long axis in a direction inclined with respect to the first slot 244. For example, the tilting angle θ of the second slot 246 may be 45 degrees.

Referring to FIGS. 4 and 5, a microwave P1 is propagated to the inner side of the ring frame 242 through the first slot 244. The polarization direction of a p-wave component A1 is formed in a direction perpendicular to the propagation direction of the microwave P1. A first microwave radiation pattern (first microwave cavity mode) is formed by the p-wave component A1 of the microwave P1, and the substrate W is heated according to the first microwave radiation pattern. The polarization direction of the p-wave component A1 is perpendicular to the long axis of the first slot 244.

Additionally, a microwave P2 is propagated downward through the second slot 246 of the ring frame 242. The polarization direction of a p-wave component A2 is formed in a direction perpendicular to the propagation direction of the microwave P2 passing through the second slot 246. The second slot 246 is tilted by the tilting angle θ with respect to the direction perpendicular to the inner wall surface 242A (i.e., the current direction), and cross polarization in which the p-wave component A2 and the s-wave component B2 are mixed occurs. The polarization direction of the p-wave component A2 and the polarization direction of an s-wave component B2 are orthogonal to each other.

The p-wave component A2 of the microwave P2 passing through the second slot 246 overlaps with the p-wave component A1 of the microwave P1 passing through the first slot 244 to form the first microwave radiation pattern. The p-wave component A2 of the microwave P2 passing through the second slot 246 and the p-wave component A1 of the microwave P1 passing through the first slot 244 have the same polarization direction and thus overlap with each other to form the first microwave radiation pattern (first microwave cavity mode). The s-wave component B2 of the microwave P2 is orthogonal to the p-wave component A2 and thus does not overlap and is independently propagated.

The s-wave component B2 of the microwave P2 passing through the second slot 246 forms a second microwave radiation pattern independent of the first microwave radiation pattern. That is, the s-wave component passing through the second slot 246 forms the second microwave radiation pattern without interfering with the p-wave component. The second microwave radiation pattern (second microwave cavity mode) independent of the first microwave radiation pattern is formed by the s-wave component B2 of the microwave P2. The second microwave radiation pattern may heat the substrate W in a pattern different from the first microwave radiation pattern.

In this case, the ratio of the p-wave component A2 and the s-wave component B2 of the microwave P2 passing through the second slot 246 is determined by the tilting angle θ. When the tilting angle θ decreases, the ratio of the s-wave component B2 increases, and when the tilting angle θ increases, the ratio of the p-wave component A2 increases. It can be considered that the radiation intensity of the microwave P2 becomes weaker when the tilting angle θ decreases because the current passing through the second slot 246 decreases.

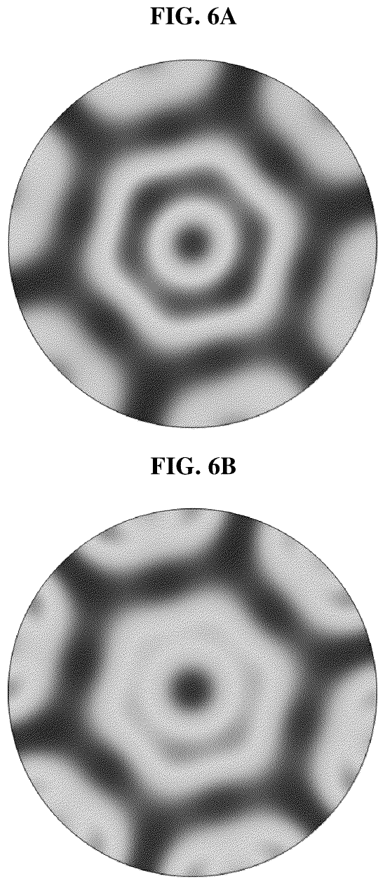

The substrate W is heated by two distinct patterns of microwave radiation, and it was confirmed that when the substrate W is heated, the two microwave radiation patterns (two microwave cavity modes) are mixed with each other, which improves the overall heating uniformity of the substrate W. FIG. 6A shows the analysis results for the temperature distribution on the substrate W when the first slot 244 is formed on the inner surface 242A of the ring frame 242 in the microwave antenna 240, and FIG. 6B shows the analysis results for the temperature distribution on the substrate W when the first slot 244 is formed on the inner surface 242A of the ring frame 242 and the second slot 246 is formed at a 45 degree angle on the lower surface 242B of the ring frame 242 in the microwave antenna 240. In FIGS. 6A and 6B, brighter shades of gray indicate relatively higher temperatures, and darker shades of gray indicate relatively lower temperatures. As shown in FIG. 6B, it was confirmed that, by using the second slot 246 formed at an inclined angle on the lower surface 242B of the ring frame 242, the overall temperature distribution on the substrate W is improved by mixing multiple microwave radiation patterns transmitted to the substrate W.

The microwave antenna 240 described above may be applied to the plasma processing apparatus 1000 using microwaves as shown in FIG. 7. The plasma processing apparatus 1000 may perform a process of heating a substrate W using microwave power. In addition, the plasma processing apparatus 1000 may perform plasma treatment (e.g., dry etching, deposition) together with heat treatment of the substrate W. That is, the heat treatment apparatus 1 may alternately perform a plasma treatment process together with heat treatment of the substrate W.

The plasma processing apparatus 1000 includes: a chamber 2000 forming a processing space PZ for the substrate W; a lower housing 1100 surrounding the outside of the chamber 2000; an upper housing 5000 coupled on top of the lower housing 1100; a gas supply module 4000 positioned above the chamber 2000 inside the upper housing 5000; a dielectric window 2500 positioned on top of the gas supply module 4000; a microwave antenna 3000 positioned on the upper edge of the dielectric window 2500; an electrode antenna 2400 positioned on the upper center of the dielectric window 2500; an RF (radio frequency) rod 2300 positioned on the upper center of the electrode antenna 2400; a matcher 2200 positioned on top of the upper housing 5000 and electrically connected to the RF rod 2300; and an RF power source 2100 positioned on top of the matcher 2200.

The chamber 2000 is located at the bottom of the plasma processing apparatus 1000 and is composed of a plurality of parts that constitute the processing space PZ for the substrate W. In the chamber 2000, an exhaust port is formed to exhaust the remaining material inside the processing space PZ, together with a shutter through which the substrate W can be inserted or discharged. In addition, a support member 1400 for supporting the substrate W is positioned at the bottom of the chamber 2000.

The RF power source 2100, the matcher 2200, the RF rod 2300, the electrode antenna 2400, and the dielectric window 2500 constitute a plasma generation module for generating plasma in the processing space PZ. The RF power source 2100 generates power of a specific frequency for generating plasma. The matcher 2200 is connected to the RF power source 2100 and adjusts the impedance of the internal circuit so that the power generated from the RF power source 2100 may be transmitted to the processing space PZ as efficiently as possible. The RF rod 2300 is connected to the matcher 2200 and transmits the power passing through the RF power source 2100 and the matcher 2200 to the electrode antenna 2400. The electrode antenna 2400 is connected to the RF rod 2300 so that an electromagnetic field is created inside the processing space PZ using power supplied through the RF rod 2300. The dielectric window 2500 is located under the electrode antenna 2400 and may be made of a dielectric so as to support the electrode antenna 2400 while at the same time allowing an electromagnetic field to be created in the processing space PZ of the chamber 2000 by the electrode antenna 2400. The dielectric window 2500 may be provided in a shape that covers the top of the chamber 2000.

The microwave antenna 3000 provides microwaves for heat treatment of the substrate W to the processing space PZ. The microwave antenna 3000 radiates microwaves supplied from a microwave power source to the processing space PZ. The microwave antenna may be positioned at the edge of the upper surface of the dielectric window 2500. The microwave antenna 3000 may be positioned so as to be in contact with the upper housing 5000.

The gas supply module 4000 supplies gas to the processing space PZ. The gas supply module 4000 is connected to an external gas supply source and injects processing gas (e.g., Cl2) into the processing space PZ. The gas supply module 4000 may be provided in a ring shape positioned between the electrode antenna 2400 and the chamber 2000. A plurality of gas supply holes 4100 is formed on the inside of the ring-shaped gas supply module 4000, and processing gas is supplied to the processing space PZ through the gas supply holes 4100.

The lower housing 1100 is a structure that surrounds the outside of the chamber 2000. Components constituting the chamber 2000 may be installed inside the lower housing 1100. An opening through which the substrate W can pass is formed in a part of the lower housing 1100. The upper housing 5000 is positioned on top of the lower housing 1100, and a flange is provided at each contact point between the lower housing 1100 and the upper housing 5000. As described with reference to FIGS. 1 to 6, the microwave antenna 3000 may heat the substrate W by radiating microwaves into the processing space PZ.

The present embodiments and drawings attached to this specification only clearly illustrate a part of the technical idea included in the present disclosure, and it is obvious that all modifications and specific embodiments that can be easily inferred by those skilled in the art within the scope of the technical idea included in the specification and drawings of the present disclosure are included in the scope of the rights of the present disclosure.

Therefore, the idea of the present disclosure should not be limited to the described embodiments, and not only the patent claims described below, but also all things that are equivalent or have equivalent modifications to these patent claims are considered to fall within the scope of the present disclosure.

What is claimed is:

1. A microwave antenna comprising:
a ring frame configured to constitute a waveguide for microwaves;
a first slot which is a space formed through an inner wall surface of the ring frame; and
a second slot which is a space formed through a lower surface of the ring frame,
wherein the second slot is formed at a tilting angle with respect to a direction perpendicular to the inner wall surface.

2. The antenna of claim 1, wherein the tilting angle is less than or equal to 90 degrees.

3. The antenna of claim 2, wherein the tilting angle is 45 degrees.

4. The antenna of claim 1, wherein a p-wave component and an s-wave component perpendicular to the p-wave component of a microwave are emitted through the second slot.

5. The antenna of claim 4, wherein by adjusting the tilting angle, a ratio of the p-wave component and the s-wave component of the microwave emitted through the second slot is adjusted.

6. The antenna of claim 4, wherein the p-wave component of the microwave passing through the second slot overlaps with a p-wave component of a microwave passing through the first slot to form a first microwave radiation pattern.

7. The antenna of claim 6, wherein the s-wave component of the microwave passing through the second slot forms a second microwave radiation pattern independent of the first microwave radiation pattern.

8. A microwave generating apparatus comprising:
a microwave power source;
a waveguide connected to the microwave power source; and
a microwave antenna connected to the waveguide,
wherein the microwave antenna comprises:
a ring frame constituting a circular waveguide;
a first slot which is a space formed through an inner wall surface of the ring frame; and
a second slot which is a space formed through a lower surface of the ring frame,
wherein the second slot is formed at a tilting angle with respect to a direction perpendicular to the inner wall surface.

9. The microwave generating apparatus of claim 8, wherein the tilting angle is less than or equal to 90 degrees.

10. The microwave generating apparatus of claim 8, wherein the tilting angle is 45 degrees.

11. The microwave generating apparatus of claim 8, wherein a p-wave component and an s-wave component perpendicular to the p-wave component of a microwave are emitted through the second slot.

12. The microwave generating apparatus of claim 11, wherein by adjusting the tilting angle, a ratio of the p-wave component and the s-wave component of the microwave emitted through the second slot is adjusted.

13. The microwave generating apparatus of claim 11, wherein the p-wave component of the microwave passing through the second slot overlaps with a p-wave component of a microwave passing through the first slot to form a first microwave radiation pattern.

14. The microwave generating apparatus of claim 13, wherein the s-wave component of the microwave passing through the second slot forms a second microwave radiation pattern independent of the first microwave radiation pattern.

15. A heat treatment apparatus using microwaves, the apparatus comprising:
a chamber configured to constitute a processing space for a substrate;
a dielectric window configured to cover a top of the chamber; and
a microwave generating apparatus configured to provide microwaves to the chamber,
wherein the microwave generating apparatus comprises:
a microwave power source;
a waveguide connected to the microwave power source; and
a microwave antenna located on top of the dielectric window and configured to provide microwaves transmitted through the waveguide to the processing space,
wherein the microwave antenna comprises:
a ring frame constituting a waveguide for microwaves;
a first slot which is a space formed through an inner wall surface of the ring frame; and
a second slot which is a space formed through a lower surface of the ring frame,
wherein the second slot is formed at a tilting angle with respect to a direction perpendicular to the inner wall surface.

16. The apparatus of claim 15, wherein the tilting angle is 45 degrees.

17. The apparatus of claim 15, wherein a p-wave component and an s-wave component perpendicular to the p-wave component of a microwave are emitted through the second slot.

18. The apparatus of claim 17, wherein by adjusting the tilting angle, a ratio of the p-wave component and the s-wave component of the microwave emitted through the second slot is adjusted.

19. The apparatus of claim 17, wherein the p-wave component of the microwave passing through the second slot overlaps with a p-wave component of a microwave passing through the first slot to form a first microwave radiation pattern.

20. The apparatus of claim 19, wherein the s-wave component of the microwave passing through the second slot forms a second microwave radiation pattern independent of the first microwave radiation pattern.
